(19) United States
(12) Patent Application Publication
(10) Pub. No.: US 2023/0126261 A1
(43) Pub. Date: Apr. 27, 2023

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Mitsuteru EMOTO, Toyota-shi (JP); Masakazu SHINKAI, Toyota-shi (JP); Yusuke MATSUKAWA, Nagoya-shi (JP)

(73) Assignee: TOYOTA JIDOSHA KABUSHIKI KAISHA, Toyota-shi (JP)

(21) Appl. No.: 17/933,288

(22) Filed: Sep. 19, 2022

(30) Foreign Application Priority Data
Oct. 25, 2021 (JP) 2021-173797

(51) Int. Cl. G06Q 30/00; G06Q 10/00; G06Q 10/08

(52) U.S. Cl. CPC G06Q 30/018; G06Q 10/20; G06Q 10/0838

(57) ABSTRACT

A controller is provided that determines, in response to an order for a sticker indicating that a predetermined part of a vehicle has been upgraded, a delivery destination of the sticker according to the predetermined part.

### CROSS REFERENCE TO THE RELATED APPLICATION

This application claims the benefit of Japanese Patent Application No. 2021-173797, filed on Oct. 25, 2021, which is hereby incorporated by reference herein in its entirety.

### BACKGROUND

### Technical Field

The present disclosure relates to an information processing apparatus, an information processing method, and a non-transitory storage medium storing a program.

### Description of the Related Art

The evaluation of used vehicles is known to vary based on options, equipment, etc. In this connection, Patent Literature 1 discloses a system in which the history of a vehicle sold as a used vehicle (parts replacement history, maintenance history, etc.) is registered in a server device and provided to consumers.

### CITATION LIST

### Patent Literature

Patent Literature 1: Japanese Patent Application Laid-Open Publication No. 2005-346170

### SUMMARY

The object of the present disclosure is to properly send a certificate related to a vehicle part.

One aspect of the present disclosure is directed to an information processing apparatus including a controller configured to determine, in response to an order for a sticker indicating that a predetermined part of a vehicle has been upgraded, a delivery destination of the sticker according to the predetermined part.

Another aspect of the present disclosure is directed to an information processing method for causing a computer to determine, in response to an order for a sticker indicating that a predetermined part of a vehicle has been upgraded, a delivery destination of the sticker according to the predetermined part.

A further aspect of the present disclosure is directed to a non-transitory storage medium storing a program configured to cause a computer to determine, in response to an order for a sticker indicating that a predetermined part of a vehicle has been upgraded, a delivery destination of the sticker according to the predetermined part.

A still further aspect of the present disclosure is directed to the program described above.

According to the present disclosure, a certificate related to a vehicle part can be appropriately sent.

### BRIEF DESCRIPTION OF THE DRAWINGS

FIG. 1 is a view illustrating a schematic configuration of a system 1 according to an embodiment;

FIG. 2 is a view illustrating an example of a sticker;

FIG. 3 is a view illustrating a position to which a sticker is attached;

FIG. 4 is a view illustrating an example of attaching a sticker to an electronic control unit (ECU) provided in a vehicle;

FIG. 5 is a block diagram schematically illustrating an example of a configuration of each of an in-vehicle device, a user terminal, a center server and an update server, which together constitute the system according to the embodiment;

FIG. 6 is a diagram illustrating a functional configuration of the center server;

FIG. 7 is a view illustrating an example of a table configuration of a vehicle information DB;

FIG. 8 is a view illustrating an example of a table configuration of a delivery destination information DB;

FIG. 9 is a view illustrating a functional configuration of the in-vehicle device;

FIG. 10 is a diagram illustrating a functional configuration of the user terminal;

FIG. 11 is a sequence diagram of processing of the system as a whole according to the embodiment;

FIG. 12 is a sequence diagram of processing of the entire system when the sticker is sent to the user of the vehicle; and

FIG. 13 is a flowchart of sticker delivery processing at the center server according to the embodiment.

### DESCRIPTION OF THE EMBODIMENTS

There is a technology for replacing or updating parts of a vehicle (vehicle parts) afterwards. For example, seats are changed from cloth to leather, or a steering wheel is changed to one with a built-in heater. In addition, by updating the software of an in-vehicle computer, it will be possible to add functions (such as safety-related functions, driving support functions, etc.) that were not installed when the new vehicle was sold. In the present disclosure, the term “upgrade” refers to making vehicle parts more sophisticated or higher in quality by replacing parts or updating software.

When the vehicle parts are upgraded, the value of the used vehicle is increased. Therefore, it is preferable for the vehicle manufacturer to certify that the upgrade was made through an official program. For example, by attaching a certificate to a maintenance notebook of a vehicle, it can be demonstrated at the time the vehicle is sold that the upgrade was made with genuine parts. The certification can also be made by means of a sticker. For example, by attaching, to the vehicle body, a sticker indicating that any of the vehicle parts included in the vehicle has been upgraded, it becomes possible to determine at a glance whether or not there has been an upgrade.

Here, the position at which the sticker is to be attached can also be determined at a predetermined position on the vehicle. The predetermined position may be a place easily visible to the user such as, for example, a center pillar (which may also be a B pillar) or the like. On the other hand, in cases where the software of the in-vehicle computer is updated, it will be necessary to perform work corresponding to the software at the time of replacement or inspection of the in-vehicle computer. Therefore, a sticker may be attached to the housing of the in-vehicle computer so as to make it easier to understand at the time of work that the software of the in-vehicle computer has been updated. In addition, when the vehicle body is processed, a sticker may be attached to a processed place or a place in the immediate vicinity of the processed place in order to guarantee the quality of the processing.

The upgrade of the vehicle parts can also be performed by the user of the vehicle. In addition, software updates can also be performed via remote operation using radio or wireless communication. In this way, in cases where the vehicle parts are upgraded without bringing the vehicle to a repair and maintenance factory or the like, it is conceivable that a sticker corresponding to the upgrade may be sent to the user of the vehicle, so that the user of the vehicle himself or herself may attach the sticker to the vehicle. However, in cases where the sticker is placed in an easily recognizable location, such as the center pillar, it can be easily attached by the vehicle user, but in cases where the sticker must be placed near upgraded vehicle parts, it may not be easily attached by the vehicle user.

For example, in cases where the sticker is to be attached to the housing of the in-vehicle computer, the user needs to know the position of the in-vehicle computer. In addition, in cases where the in-vehicle computer is covered with parts such as interiors, it is also necessary to know how to remove the interiors or the like. Also, it may take time to remove the interiors, or a special tool may be required. Therefore, even if the sticker is sent to the user of the vehicle, it may not be attached to an appropriate position. An information processing apparatus, which is one of the aspects of the present disclosure, solves such problems.

The information processing apparatus according to one aspect of the present disclosure includes a controller. In response to an order for a sticker indicating that a predetermined part of a vehicle has been upgraded, the controller determines a delivery destination of the sticker corresponding to the predetermined part. For example, the controller may determine that the sticker has been ordered, not only in cases where the user directly orders the sticker, but also in cases where a situation arises that requires the sticker to be attached. For example, it may be determined that the sticker has been ordered, based on the fact that the user has performed an action of ordering the sticker, the fact that the user has placed an order for the vehicle part, the fact that the user has upgraded the vehicle part, the fact that the vehicle part has been upgraded without depending on the user, or the like. For example, in cases where the software update of the in-vehicle computer is performed by using wireless communication, it may be considered that the sticker has been ordered based on the fact that the software update has been performed. In addition, a server or the like that has performed the software update may place an order for the sticker. Further, in cases where the user orders a vehicle part for upgrade, it may be treated as if an order for a sticker was also made. The controller may receive the order for the sticker from a user's terminal, an in-vehicle device, a computer that manages the upgrade of the vehicle part, or the like.

The predetermined part is a part that can be upgraded. The upgrade of the predetermined part can include an upgrade of hardware and an upgrade of software. Note that in cases where the software of the in-vehicle computer has been updated, it may be considered that the software has been upgraded, or it may be considered that the in-vehicle computer has been upgraded. In addition, the upgrade can include replacement of the part and new installation of the part.

The sticker is a certification associated with the vehicle part. The sticker includes information indicating that the predetermined part has been upgraded. For example, the name of the predetermined part, the content of the upgrade, or the like may be described. Alternatively, a two-dimensional code corresponding to the name of the predetermined part, the content of the upgrade, or the like may be printed, or an electronic tag corresponding to the name of the predetermined part, the content of the upgrade, or the like may be embedded. Note that the sticker may be a laminated piece of paper, a metal plate, or the like.

The delivery destination of the sticker is associated with the predetermined part. The position at which the sticker is attached varies depending on the predetermined part, and the delivery destination of the sticker varies depending on the position at which the sticker is attached. For example, in cases where it can be determined that it is easy for the user of the vehicle to attach the sticker to the vehicle, the controller determines the delivery destination so that the user of the vehicle will receive the sticker. The delivery destination in this case is, for example, the location of the user of the vehicle. On the other hand, for example, in cases where the controller can determine that it is difficult for the user of the vehicle to attach the sticker to the vehicle, the controller determines the facility used by the user to maintain the vehicle as the delivery destination. The delivery destination in this case is, for example, the location of a dealer or a repair and maintenance shop, or the like.

In cases where it is difficult for the user to attach the sticker himself or herself, the sticker may be delivered to a dealer, a repair and maintenance factory, or the like, and when the user deposits the vehicle with the dealer or the repair and maintenance factory at a later date for maintenance of the vehicle or for having the sticker attached thereto, a worker may attach the sticker to the vehicle at the dealer or the repair and maintenance factory. In this way, the sticker can be attached at an appropriate position.

Hereinafter, embodiments of the present disclosure will be described based on the accompanying drawings. The configurations of the following embodiments are examples, and the present disclosure is not limited to the configurations of the embodiments. In addition, the following embodiments can be combined with one another as long as such combinations are possible and appropriate.

### First Embodiment

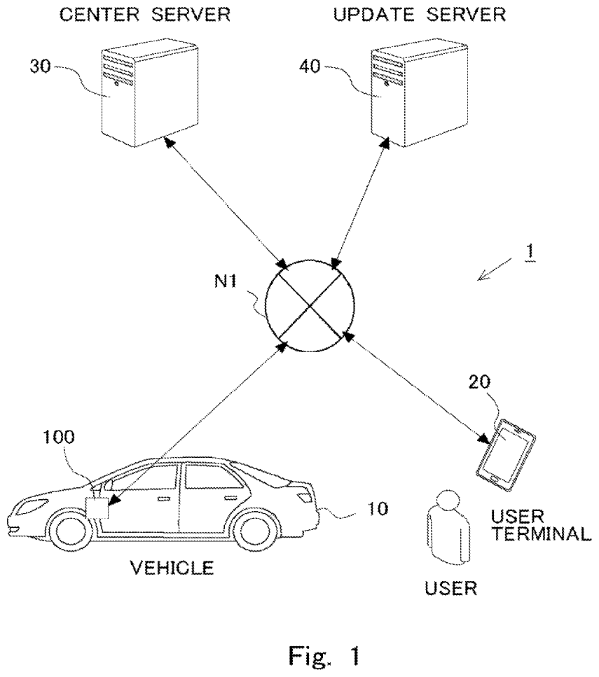

FIG. 1 is a view illustrating a schematic configuration of a system 1 according to an embodiment. In the example of FIG. 1, the system 1 includes an in-vehicle device 100 mounted on a vehicle 10, a user terminal 20 carried by a user of the vehicle 10, a center server 30, and an update server 40.

The in-vehicle device 100 includes a computer mounted on the vehicle 10. The in-vehicle device 100 performs control of the vehicle 10 and the like by executing installed software.

The user terminal 20 is an information processing apparatus used by a user associated with the vehicle 10. Note that the user associated with the vehicle 10 may be the user of the vehicle 10.

The center server 30 is a server device that manages a database storing the delivery destinations of stickers according to upgrades when the upgrades of vehicle parts are implemented. The information about the delivery destinations (delivery destination information) includes information about the vehicle parts, information about the delivery destinations, and the like. Upon receiving a request for the issuance of a sticker from the user terminal 20 or the update server 40, the center server 30 determines a delivery destination of the sticker, and outputs information so that the sticker is delivered to this delivery destination.

The update server 40 is a server device that manages the upgrade of the software for the in-vehicle device 100, and is also a server device that remotely executes the upgrade of the software for the in-vehicle device 100. The update server 40 stores software to be installed on the in-vehicle device 100, and remotely installs the software on the in-vehicle device 100 thereby to upgrade the in-vehicle device 100 or to upgrade the software thereof. The update server 40 obtains, from another computer, the software to be installed on the in-vehicle device 100.

The user of the vehicle 10 whose vehicle parts have been upgraded can request the center server 30 to issue a sticker via the user terminal 20. In addition, in cases where the software of the in-vehicle device 100 is updated, the update server 40 can request the center server 30 to issue a sticker. Note that in cases where the software of the in-vehicle device 100 is updated, the user terminal 20 or the in-vehicle device 100 can also request the center server 30 to issue a sticker.

Here, the sticker in the present disclosure will be described. The sticker in the present disclosure is a label that is attached to the vehicle 10 in order to certify that at least one of plurality of vehicle parts included in the vehicle 10 has been upgraded. As the plurality of vehicle parts included in the vehicle 10, there can be exemplified, for example, an electronic control unit (ECU), an in-vehicle computer, communication devices, infotainment terminals, air conditioning devices, seats, a steering wheel, doors, a sunroof, mirrors, other electric components, and the like. The in-vehicle device 100 can include these devices or components. Note that in the description of the embodiment, the target of upgrade is a vehicle part, but the target of upgrade may be a component composed of a plurality of vehicle parts. In this case, the component can be upgraded by replacing several vehicle parts that make up the component.

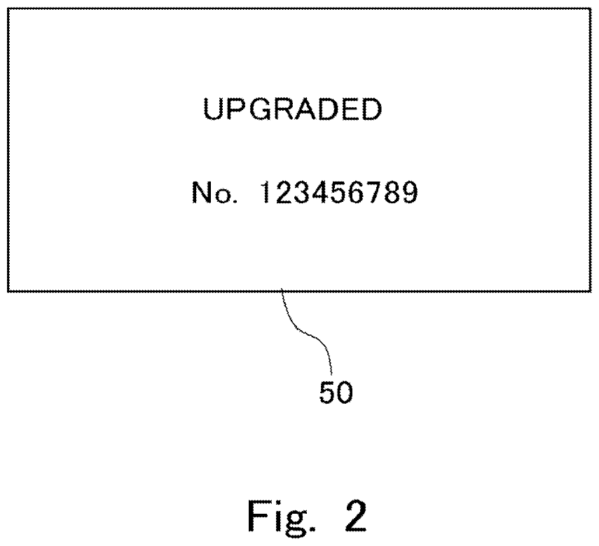

FIG. 2 is a view illustrating an example of a sticker 50. The sticker 50 describes a statement or the like to the effect that an upgrade has been performed for any vehicle part, or to the effect that any vehicle part has been replaced with an upgraded product. The wording described on the sticker 50 is not limited to a specific one, as long as it can be determined that some update has been performed on the vehicle 10. The sticker 50 may include a two-dimensional code or an electronic tag for identifying the upgraded vehicle part, the content of the upgrade, or the like.

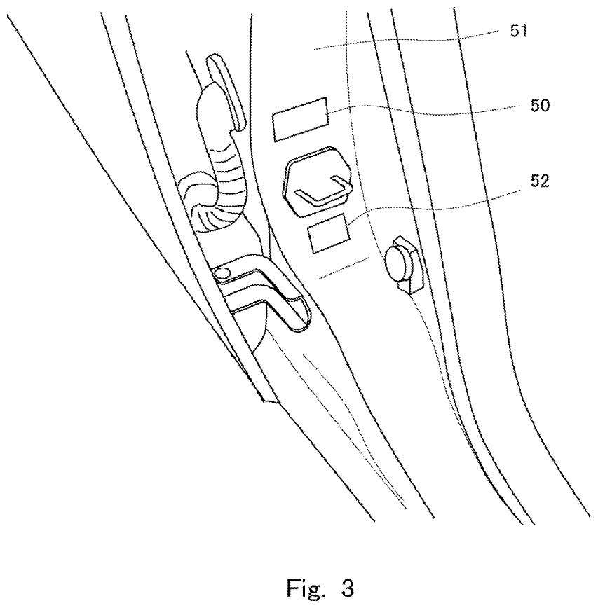

The sticker 50 is attached to a predetermined position of the vehicle 10 according to the content of the upgrade. FIG. 3 is a view illustrating a position at which the sticker 50 is attached. FIG. 3 is a view of a body frame of the vehicle 10 as seen from the right front side. The lower side of the figure is a side sill, and the center thereof is a center pillar 51 (also referred to as a B pillar). In this example, it is assumed that the sticker 50 is attached to a predetermined region of the center pillar 51. The location of the attachment may be in the vicinity of a caution plate 52 on which a chassis number or the like is described. By arranging the sticker 50 in such a location, it becomes possible to easily confirm the presence or absence of an upgrade by opening a door.

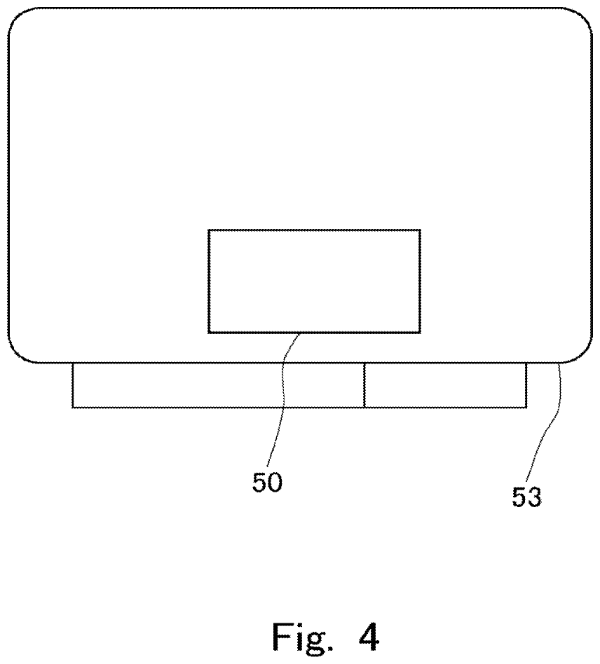

On the other hand, FIG. 4 is a view illustrating an example of attaching the sticker 50 to an electronic control unit 53 (ECU 53) provided in the vehicle 10. In this way, in cases where the sticker 50 is attached to the vehicle part itself, information such as “The target vehicle part is an upgraded product.” is displayed on the sticker 50. In addition, the sticker 50 may be attached in the vicinity of the vehicle part. In such a case, too, a similar sticker 50 is attached.

The center server 30 determines the delivery destination of the sticker 50 according to the updated vehicle part. The delivery destination is determined in such a manner that the sticker 50 to be attached to the center pillar 51 illustrated in FIG. 3 is delivered to the user of the vehicle 10, while the sticker 50 to be attached to or near the vehicle part illustrated in FIG. 4 is delivered to a place associated with the vehicle 10, such as for example a dealer, a repair and maintenance factory, or the like (hereinafter, also simply referred to as a factory). The sticker 50 delivered to the user of the vehicle 10 is attached by the user of the vehicle 10 himself or herself, whereas the sticker 50 delivered to the factory is attached by a worker in the factory. Therefore, even if the user of the vehicle 10 does not know the position of the vehicle part, the user can have the sticker 50 attached thereto at the factory. Note that the position at which the user of the vehicle 10 attaches the sticker 50 is not limited to the center pillar 51.

The in-vehicle device 100, the user terminal 20, the center server 30, and the update server 40 are connected to one another by means of a network N1. Note that the network N1 is, for example, a worldwide public communication network such as the Internet or the like, and a WAN (Wide Area Network) or other communication networks may be adopted. Also, the network N1 may include a telephone communication network such as a mobile phone network or the like, and/or a wireless communication network such as Wi-Fi (registered trademark) or the like. FIG. 1 illustrates, by way of example, one vehicle 10 and one user terminal 20, but there can be a plurality of vehicles 10 and a plurality of user terminals 20.

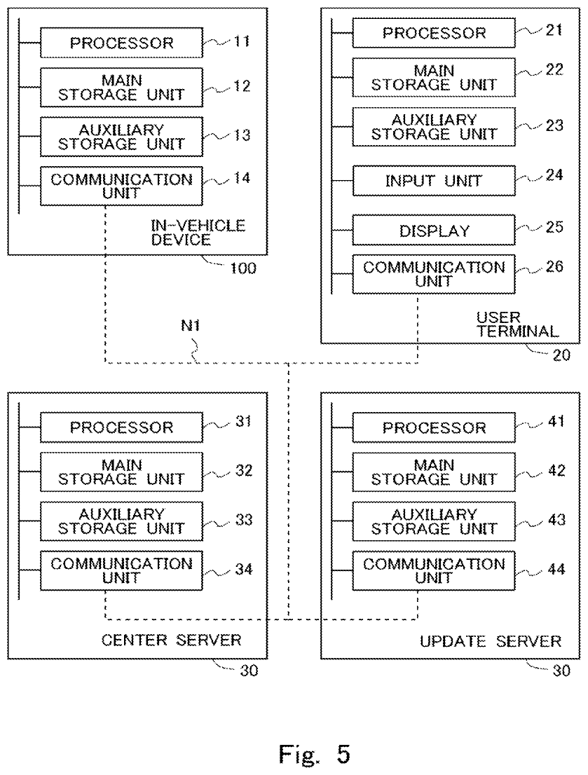

The hardware configurations and functional configurations of the in-vehicle device 100, the user terminal 20, the center server 30, and the update server 40 will be described based on FIG. 5. FIG. 5 is a block diagram schematically illustrating one example of the configuration of each of the in-vehicle device 100, the user terminal 20, the center server 30, and the update server 40, which together constitute the system 1 according to the embodiment.

The center server 30 has a configuration of a general computer. The center server 30 includes a processor 31, a main storage unit 32, an auxiliary storage unit 33, and a communication unit 34. These components are connected to one another by means of a bus. The processor 31 is an example of a controller. Also, the main storage unit 32 and the auxiliary storage unit 33 are examples of a memory.

The processor 31 is a CPU (Central Processing Unit), a DSP (Digital Signal Processor), or the like. The processor 31 controls the center server 30 thereby to perform various information processing operations. The main storage unit 32 is a RAM (Random Access Memory), a ROM (Read Only Memory), or the like. The auxiliary storage unit 33 is an EPROM (Erasable Programmable ROM), a hard disk drive (HDD), a removable medium, or the like. The auxiliary storage unit 33 stores an operating system (OS), various programs, various tables, and the like. The processor 31 loads a program stored in the auxiliary storage unit 33 into a work area of the main storage unit 32 and executes the program, so that each component or the like is controlled through the execution of the program. Thus, the center server 30 realizes functions matching predetermined purposes, respectively. The main storage unit 32 and the auxiliary storage unit 33 are computer readable recording media. Note that the center server 30 may be a single computer or a plurality of computers that cooperate with one another. In addition, the information stored in the auxiliary storage unit 33 may be stored in the main storage unit 32. Also, the information stored in the main storage unit 32 may be stored in the auxiliary storage unit 33.

The communication unit 34 is a means or unit that communicates with the in-vehicle device 100 (which may be the vehicle 10), the user terminal 20, and the update server 40 via the network N1. The communication unit 34 is, for example, a LAN (Local Area Network) interface board, a wireless communication circuit for wireless communication, or the like. The LAN interface board or the wireless communication circuit is connected to the network N1.

Now, the update server 40 has a configuration of a computer. When obtaining update data of the software for the in-vehicle device 100 from another terminal or the like, the update server 40 remotely installs the update data thereby to update the software in the corresponding in-vehicle device 100 via wireless communication. Well-known techniques can be used for installing and updating the software via wireless communication. The update server 40 includes a processor 41, a main storage unit 42, an auxiliary storage unit 43, and a communication unit 44. These components are connected to one another by means of a bus. The processor 41, the main storage unit 42, the auxiliary storage unit 43, and the communication unit 44 are the same as the processor 31, the main storage unit 32, the auxiliary storage unit 33, and the communication unit 34 of the center server 30, respectively, and hence, the description thereof will be omitted.

Next, the in-vehicle device 100 has a configuration of a computer. The in-vehicle device 100 includes a processor 11, a main storage unit 12, an auxiliary storage unit 13, and a communication unit 14. These components are connected to one another by means of a bus. The processor 11, the main storage unit 12, the auxiliary storage unit 13, and the communication unit 14 are the same as the processor 31, the main storage unit 32, the auxiliary storage unit 33, and the communication unit 34 of the center server 30, respectively, and hence, the description thereof will be omitted.

Now, the user terminal 20 will be described. The user terminal 20 is, for example, a smart phone, a mobile phone, a tablet terminal, a personal information terminal, a wearable computer (such as a smart watch or the like), or a small computer such as a personal computer (PC). The user terminal 20 includes a processor 21, a main storage unit 22, an auxiliary storage unit 23, an input unit 24, a display 25, and a communication unit 26. These components are connected to one another by means of a bus. The processor 21, the main storage unit 22 and the auxiliary storage unit 23 are the same as the processor 31, the main storage unit 32 and the auxiliary storage unit 33 of the center server 30, respectively, and hence, the description thereof will be omitted.

The input unit 24 is a means or unit that receives an input operation performed by the user, and is, for example, a touch panel, a mouse, a keyboard, a push button, or the like. The display 25 is a means or unit for presenting information to the user, and is, for example, an LCD (Liquid Crystal Display), an EL (Electroluminescence) panel, or the like. The input unit 24 and the display 25 may be configured as a single touch panel display.

The communication unit 26 is a communication means or unit for connecting the user terminal 20 to the network N1. The communication unit 26 is a circuit for communicating with another device (e.g., the center server 30, or the like) via the network N1 by making use of a mobile communication service (e.g., a telephone communication network such as 5G (5th Generation), 4G (4th Generation), 3G (3rd Generation), LTE (Long Term Evolution) or the like), and/or a wireless communication network such as Wi-Fi (registered trademark), Bluetooth (registered trademark) Low Energy, NFC (Near Field Communication), UWB (Ultra Wideband) or the like.

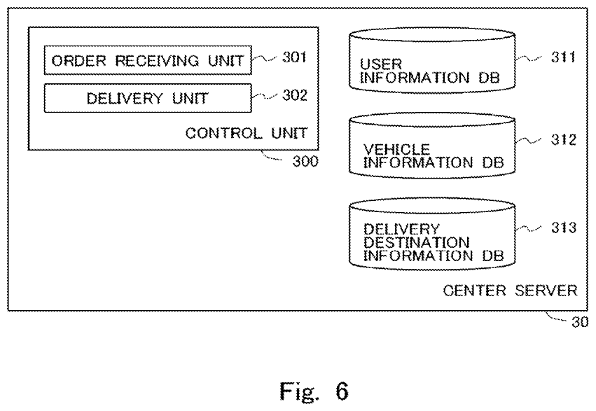

Then, the functions of the center server 30 will be described. FIG. 6 is a view illustrating by way of example a functional configuration of the center server 30. The center server 30 includes, as its functional components, a control unit 300, a user information DB 311, a vehicle information DB 312, and a delivery destination information DB 313. The processor 31 of the center server 30 executes the processing of the control unit 300 by a computer program on the main storage unit 32. However, any of the individual functional components or a part of the processing thereof may be implemented by a hardware circuit. The control unit 300 includes an order receiving unit 301 and a delivery unit 302.

The user information DB 311, the vehicle information DB 312, and the delivery destination information DB 313 are built by a program of a database management system (DBMS) that is executed by the processor 31 to manage data stored in the auxiliary storage unit 33. The user information DB 311, the vehicle information DB 312, and the delivery destination information DB 313 are, for example, relational data bases.

Here, note that any of the individual functional components of the center server 30 or a part of the processing thereof may be implemented by another or other computers connected to the network N1.

The order receiving unit 301 obtains data about the order for the sticker by interacting with the user terminal 20, the update server 40, or the in-vehicle device 100. The order receiving unit 301 may generate a user interface screen for interacting with the user terminal 20. The user interface screen may be generated by using a built-in web server or the like. In the present embodiment, the order receiving unit 301 generates and provides a list of products including vehicle parts compatible with the vehicle 10, for example, based on the identifier of the vehicle 10 received from the user terminal 20. Then, the order receiving unit 301 receives the order for the sticker 50 designated by the user terminal 20. Note that when a vehicle part for upgrade is ordered, the order receiving unit 301 may accept the order for the sticker 50 on the assumption that the sticker 50 is also ordered.

The delivery unit 302 determines the delivery destination of the sticker 50 in response to the order for the sticker 50. The relationship between the vehicle part and the delivery destination thereof has been stored in the delivery destination information DB 313. The delivery unit 302 obtains from the delivery destination information DB 313 the delivery destination of the sticker 50 corresponding to the vehicle part whose order has been received by the order receiving unit 301, and generates data (ordering data) for ordering the sticker 50. This ordering data is transmitted to a base (a factory or the like) that manufactures or sells the sticker 50.

The user information DB 311 is formed by storing user information in the auxiliary storage unit 33. The user information is information about the user of the vehicle 10, and includes information about the user ID, the name of the user, the telephone number of the user, the location of the user, and the like.

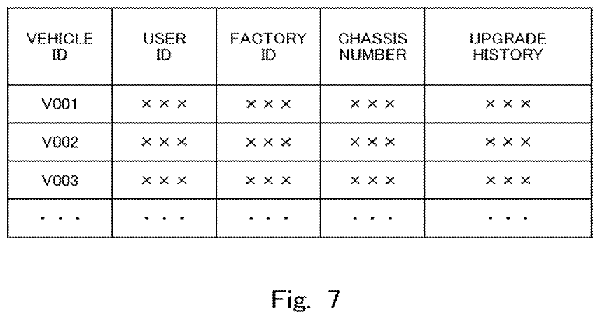

Next, the configuration or structure of the vehicle information stored in the vehicle information DB 312 will be described based on FIG. 7. FIG. 7 is a view illustrating an example of a table configuration of the vehicle information DB 312. The vehicle information table has fields for vehicle ID, user ID, factory ID, chassis number, and upgrade history, respectively. In the vehicle ID field, information that can identify each vehicle (vehicle ID) is entered. A vehicle ID has been assigned to each vehicle 10 in advance. In the user ID field, information (user ID) that can identify the user associated with each vehicle 10, such as the user of each vehicle 10, is entered.

In the factory ID field, information that can identify the factory that inspects or maintains each vehicle 10, e.g., information about the dealer who sold each vehicle 10 or the repair and maintenance factory designated by each user, is entered. In the chassis number field, information about the chassis number of each vehicle 10 is entered. Note that the chassis number is a number unique to each vehicle, and hence, the chassis number may be used as the vehicle ID. In the upgrade history field, information related to the history of upgrade of each vehicle part is entered. For example, the part number of the part attached by the upgrade, the name of the upgraded software, the version of the upgraded software, or the like is entered.

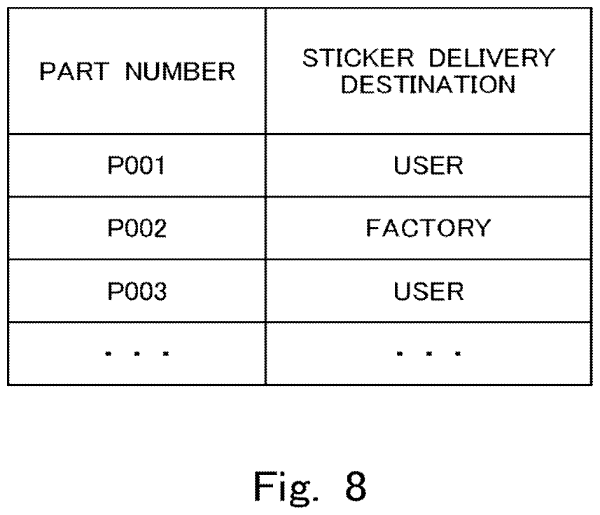

Then, the configuration of the delivery destination information stored in the delivery destination information DB 313 will be described based on FIG. 8. FIG. 8 is a view illustrating an example of a table configuration of the delivery destination information DB 313. A delivery destination information table has fields for part number and sticker delivery destination, respectively. In the part number field, the number of each vehicle part (part number) is entered. The part number of each part differs between the part before the upgrade and the part after the upgrade. Here, note that the part number of a vehicle part for which a sticker will not be issued even if upgraded is not entered in the delivery destination information DB 313.

In the sticker delivery destination field, information about the delivery destination of a sticker 50 at the time of an upgrade is entered. In cases where the sticker 50 is to be delivered to the location of the user of a vehicle 10, “user” is entered in the sticker delivery destination field. “User” is entered in the sticker delivery destination field in cases where the user of the vehicle 10 can attach the sticker 50 by himself or herself, e.g., in cases where the sticker 50 is to be attached to the center pillar 51 of the vehicle 10.

On the other hand, in cases where the sticker 50 is to be delivered to a factory or the like, “factory” is entered in the sticker delivery destination field. “Factory” is entered in the sticker delivery destination field in cases where it is difficult for the user of the vehicle 10 to attach the sticker 50 by himself or herself, e.g., in the case of a sticker 50 that is to be attached to a location other than the center pillar 51 of the vehicle 10, or in the case of a sticker 50 that is to be attached to a vehicle part or a location in the vicinity thereof.

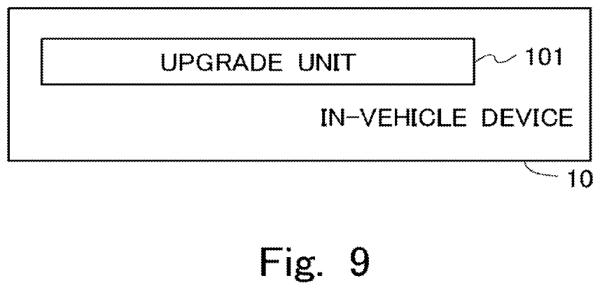

Next, the functions of the in-vehicle device 100 will be described. FIG. 9 is a view illustrating a functional configuration of the in-vehicle device 100. The in-vehicle device 100 has an upgrade unit 101 as its functional component. The processor 11 of the in-vehicle device 100 executes the processing of the upgrade unit 101 by a computer program on the main storage unit 12. However, any of the individual functional components or a part of the processing thereof may be implemented by a hardware circuit.

The upgrade unit 101 receives the update data for the software of the in-vehicle device 100 from the update server 40, and executes the upgrade of the software. The update data is transmitted from the update server 40. When the upgrade is completed, the upgrade unit 101 notifies the update server 40 to that effect. Note that in cases where the user makes a predetermined input to the in-vehicle device 100, the in-vehicle device 100 may request the update server 40 to transmit the upgrade data. In addition, in cases where a predetermined request is made from the user terminal 20 to the update server 40, the update server 40 may transmit the update data to the in-vehicle device 100.

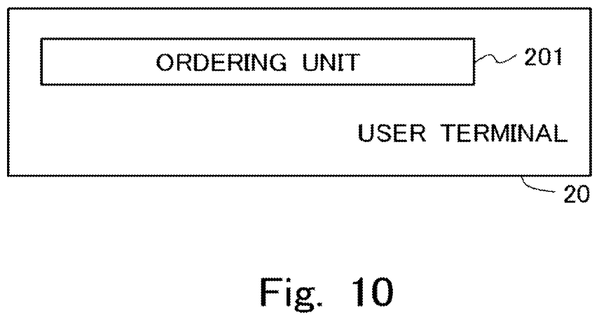

Now, the functions of the user terminal 20 will be described. FIG. 10 is a diagram illustrating a functional configuration of the user terminal 20. The user terminal 20 has an ordering unit 201 as its functional component. The processor 21 of the user terminal 20 executes the processing of the ordering unit 201 by a computer program on the main storage unit 22.

The ordering unit 201 generates data for ordering a vehicle part or a sticker according to the input to the input unit 24 of the user terminal 20. This data includes, for example, the vehicle ID, the user ID, and the part number of the vehicle part. For example, when the user accesses a website for ordering parts via the user terminal 20 and enters the vehicle ID, the user ID, and the vehicle part, data for ordering is generated and transmitted to the center server 30. Note that the sticker 50 may be ordered at the same time when the vehicle part is ordered, or only the sticker 50 may be ordered separately.

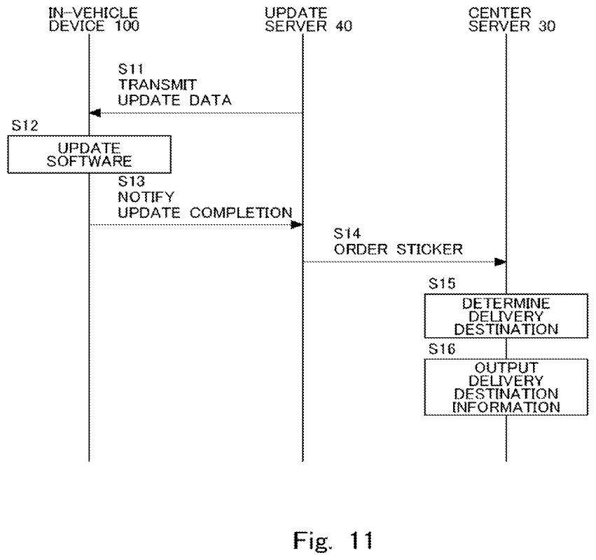

Next, the processing of the system as a whole at the time of determining the delivery destination of the sticker 50 will be described. FIG. 11 is a sequence diagram of the processing of the entire system 1 according to the embodiment. Note that the following explanation will be made on the assumption that necessary information has been stored in each database. FIG. 11 illustrates processing in the case where the in-vehicle device 100 performs a software update in accordance with a command or instruction from the update server 40.

Upon obtaining the data for updating the software of the in-vehicle device 100, the update server 40 identifies the in-vehicle device 100 to be targeted and transmits the update data to it (S11). Note that the update data is uploaded to the update server 40 by a manager of the update server 40. The in-vehicle device 100, which has received the update data, executes the software update (S12). Then, when the update is completed, an update completion notification is transmitted from the in-vehicle device 100 to the update server 40 (S13). This notification includes, for example, information about the vehicle ID and the updated software.

The update server 40, which has received the update completion notification, orders the sticker 50 from the center server 30 (S14). At this time, the vehicle ID and the part number corresponding to the updated software are transmitted to the center server 30. The center server 30 receives an order for the sticker 50, and determines the delivery destination of the sticker 50 (S15). Here, the sticker 50 corresponding to the update of the software of the in-vehicle device 100 is attached to the in-vehicle device 100. Therefore, the delivery destination of the sticker 50 is a “factory”. That is, in the delivery destination information DB 313, “factory” is entered in the sticker delivery destination field of the record of the part number corresponding to the update data, and hence, the center server 30 determines the delivery destination as the location of the factory. Note that even in the case of the update of the software, the sticker 50 may be attached to the center pillar 51. In this case, “user” has been entered in the sticker delivery destination field.

Then, the center server 30 outputs information about the delivery destination (S16). The information about the delivery destination referred to herein is information indicating the address, name of individual or entity, or the like of the delivery destination of the sticker 50, and includes, for example, information to be printed as a delivery label at the time of delivering the sticker 50. For example, in a factory that manufactures the sticker 50, the sticker 50 is shipped by attaching this delivery label to the wrapping paper of the sticker 50.

Here, note that in the example illustrated in FIG. 11, the sticker 50 is ordered from the update server 40 to the center server 30, but instead of this, the sticker 50 may be ordered from the in-vehicle device 100 or the user terminal 20 to the center server 30. In addition, the update server 40 may place an order for the sticker 50 to the center server 30 immediately after transmitting the update data.

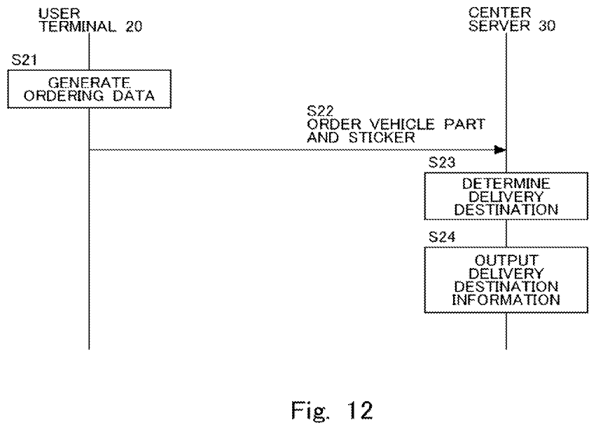

Next, the processing of the system as a whole in the case where the sticker 50 is sent to the user of the vehicle 10 will be described. FIG. 12 is a sequence diagram of the processing of the entire system in the case where the sticker 50 is sent to the user of the vehicle 10. Here, note that the following explanation will be made on the assumption that necessary information has been stored in each database. FIG. 12 illustrates the processing in the case of ordering a vehicle part from the user terminal 20.

When a user makes a predetermined input to the user terminal 20 for ordering a vehicle part, ordering data is generated at the user terminal 20 (S21). This ordering data includes information such as a part number, a vehicle ID, a user ID, and the like. For example, when the user terminal 20 accesses a website on the Internet, a screen for entering a part number, a vehicle ID, and a user ID is displayed on the display 25. Then, when the user enters the part number, the vehicle ID, and the user ID via the input unit 24, information about the order for the vehicle part is transmitted to the center server 30 (S22). Note that only the sticker 50 may be ordered from the user terminal 20.

The center server 30, which has received the order for the vehicle part, determines the delivery destination of the sticker 50 (S23). This sticker 50 is defined as a sticker 50 that is to be attached to the center pillar 51. That is, in the delivery destination information DB 313, “user” has been entered in the sticker delivery destination field of the record of the part number corresponding to the vehicle part, and hence, in the center server 30, the delivery destination of the sticker 50 is determined as the user. At this time, the delivery destination is determined so that the sticker 50 is delivered to the address corresponding to the user ID stored in the user information DB 311.

Then, the center server 30 outputs information about the delivery destination (S24). The information about the delivery destination referred to herein is information indicating the address, name of individual or entity, or the like of the delivery destination of the sticker 50, and includes, for example, information to be printed as a delivery label at the time of delivering the sticker 50. For example, in a factory that manufactures the sticker 50, the sticker 50 is shipped by attaching this delivery label to the wrapping paper of the sticker 50. Note that the vehicle part and the sticker 50 may be delivered separately or together.

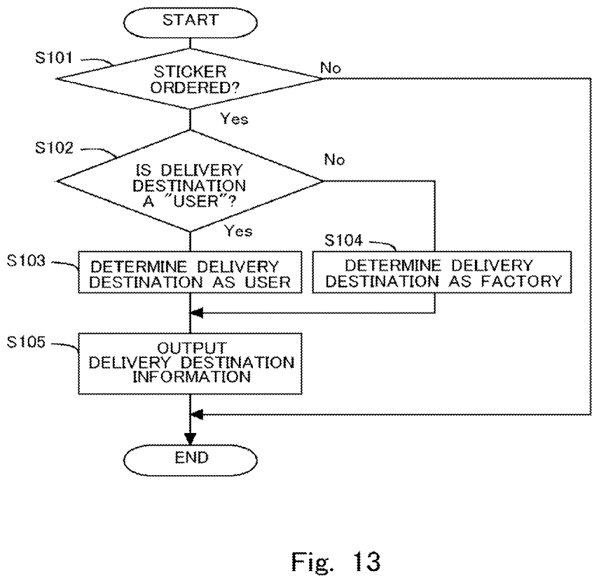

Then, the delivery processing of the sticker 50 in the center server 30 will be described. FIG. 13 is a flowchart of the delivery processing of the sticker 50 in the center server 30 according to the embodiment. The processing illustrated in FIG. 13 is executed at predetermined time intervals in the center server 30. Here, note that the following explanation will be made on the assumption that necessary information has been stored in each database.

In step S101, the order receiving unit 301 determines whether or not a sticker 50 has been ordered from the in-vehicle device 100, the user terminal 20, or the update server 40. Note that, as an alternative, in step S101, the order receiving unit 301 may determine whether or not an upgrade has been made for which a sticker 50 is issued, or whether or not a vehicle part has been ordered for which a sticker 50 is issued. When an affirmative determination is made in step S101, the processing proceeds to step S102, whereas when a negative determination is made, this routine is ended.

In step S102, the delivery unit 302 determines whether or not the delivery destination of the sticker 50 is a “user”. The delivery unit 302 extracts, from the sticker delivery destination field of the delivery destination information DB 313, the delivery destination corresponding to the part number included in the information received at the time of ordering the sticker 50. Then, it is determined whether or not the delivery destination thus extracted is a “user”. When an affirmative determination is made in step S102, the processing proceeds to step S103, whereas when a negative determination is made, the processing proceeds to step S104.

In step S103, the delivery unit 302 determines the delivery destination as the location of the user. The location of the user has been stored in the user information DB 311 in association with the user ID thereof. On the other hand, in step S104, the delivery unit 302 determines the delivery destination as the location of a factory. The location of the factory has been stored in the auxiliary storage unit 33 in association with the factory ID thereof. Then, in step S105, the delivery unit 302 outputs the delivery destination determined in step S103 or step S104. At this time, for example, data for printing an address or the like corresponding to the delivery destination on a delivery label may be transmitted to a computer at the factory where the sticker 50 is shipped.

As described above, according to the embodiment, the delivery destination of the sticker 50 is determined in accordance with the position at which the sticker 50 is to be attached, so that the sticker 50 can be attached at an appropriate position.

### OTHER EMBODIMENTS

The above-described embodiment is merely an example, but the present disclosure can be implemented with appropriate modifications without departing from the spirit thereof.

The processing and/or means (devices, units, parts, etc.) described in the present disclosure can be freely combined and implemented as long as no technical contradiction occurs.

The processing described as being performed by one device or unit may be shared and performed by a plurality of devices or units. Alternatively, the processing described as being performed by different devices or units may be performed by one device or unit. In a computer system, a hardware configuration (server configuration) for realizing each function thereof can be changed in a flexible manner. For example, the center server 30 may include a part or all of the functions of the update server 40. Also, for example, the update server 40 may include a part or all of the functions of the center server 30.

The present disclosure can also be realized by supplying to a computer a computer program in which the functions described in the above-described embodiment are implemented, and reading out and executing the program by means of one or more processors included in the computer. Such a computer program may be provided to the computer by a non-transitory computer readable storage medium that can be connected to a system bus of the computer, or may be provided to the computer via a network. The non-transitory computer readable storage medium includes, for example, any type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read-only memory (ROM), a random-access memory (RAM), an EPROM, an EEPROM, a magnetic card, a flash memory, an optical card, or any type of medium suitable for storing electronic commands or instructions.

What is claimed is:

1. An information processing apparatus comprising a controller configured to determine, in response to an order for a sticker indicating that a predetermined part of a vehicle has been upgraded, a delivery destination of the sticker according to the predetermined part.

2. The information processing apparatus according to claim 1, further comprising
a memory configured to store a relationship between the predetermined part and the delivery destination.

3. The information processing apparatus according to claim 1, wherein
the predetermined part includes an electronic control device on which software to be upgraded by remote operation is executed.

4. The information processing apparatus according to claim 1, wherein
in cases where the sticker is to be attached to a predetermined position of the vehicle regardless of a position of the predetermined part in the vehicle, the controller determines the delivery destination as a location of a user of the vehicle.

5. The information processing apparatus according to claim 1, wherein
in cases where the sticker is to be attached to the predetermined part in the vehicle, the controller determines the delivery destination as a predetermined place where the vehicle is to be maintained.

6. The information processing apparatus according to claim 1, wherein
the controller receives, via a communication unit, information about the order for the sticker from a terminal of a user of the vehicle or a server that manages an upgrade of the predetermined part.

7. The information processing apparatus according to claim 1, wherein
the controller outputs information for delivering the sticker to the delivery destination thus determined.

8. An information processing method for causing a computer to determine, in response to an order for a sticker indicating that a predetermined part of a vehicle has been upgraded, a delivery destination of the sticker according to the predetermined part.

9. The information processing method according to claim 8, wherein
the computer stores a relationship between the predetermined part and the delivery destination in a memory.

10. The information processing method according to claim 8, wherein
the predetermined part includes an electronic control device on which software to be upgraded by remote operation is executed.

11. The information processing method according to claim 8, wherein
in cases where the sticker is to be attached to a predetermined position of the vehicle regardless of a position of the predetermined part in the vehicle, the computer determines the delivery destination as a location of a user of the vehicle.

12. The information processing method according to claim 8, wherein
in cases where the sticker is to be attached to the predetermined part in the vehicle, the computer determines the delivery destination as a predetermined place where the vehicle is to be maintained.

13. The information processing method according to claim 8, wherein
the computer receives, via a communication unit, information about the order for the sticker from a terminal of a user of the vehicle or a server that manages an upgrade of the predetermined part.

14. The information processing method according to claim 8, wherein
the computer outputs information for delivering the sticker to the delivery destination thus determined.

15. A non-transitory storage medium storing a program configured to cause a computer to determine, in response to an order for a sticker indicating that a predetermined part of a vehicle has been upgraded, a delivery destination of the sticker according to the predetermined part.

16. The non-transitory storage medium storing a program according to claim 15, wherein
the program causes the computer to store a relationship between the predetermined part and the delivery destination in a memory.

17. The non-transitory storage medium storing a program according to claim 15, wherein
the predetermined part includes an electronic control device on which software to be upgraded by remote operation is executed.

18. The non-transitory storage medium storing a program according to claim 15, wherein
in cases where the sticker is to be attached to a predetermined position of the vehicle regardless of a position of the predetermined part in the vehicle, the program causes the computer to determine the delivery destination as a location of a user of the vehicle.

19. The non-transitory storage medium storing a program according to claim 15, wherein
in cases where the sticker is to be attached to the predetermined part in the vehicle, the program causes the computer to determine the delivery destination as a predetermined place where the vehicle is to be maintained.

20. The non-transitory storage medium storing a program according to claim 15, wherein
the program causes the computer to receive, via a communication unit, information about the order for the sticker from a terminal of a user of the vehicle or a server that manages an upgrade of the predetermined part.
